(19) United States
(12) Patent Application Publication
(10) Pub. No.: US 2022/0074447 A1
(43) Pub. Date: Mar. 10, 2022

(54) DOUBLE BEARING

(71) Applicant: TRITON SYSTEMS, INC., Chelmsford, MA (US)

(72) Inventors: Stephen SCHOENHOLTZ, Wilmington, MA (US); Tyson LAWRENCE, Highlands Ranch, CO (US); Jennifer SMITH, Ayer, MA (US); Rafael MANDUJANO, Arlington, MA (US); Grant DREW, Sanbornton, NH (US)

(21) Appl. No.: 17/472,503

(22) Filed: Sep. 10, 2021

Related U.S. Application Data
(60) Provisional application No. 63/076,725, filed on Sep. 10, 2020.

(51) Int. Cl. F16C 23/04

(52) U.S. Cl. CPC F16C 23/045

(57) ABSTRACT

Disclosed are bearing assemblies including a compliant layer within a mounting socket for reducing wear of the bearing.

### CROSS-REFERENCE TO RELATED APPLICATION

This application claims the benefit of U.S. Provisional Patent Application No. 63/076,725 filed Sep. 10, 2020, the entirety of which is incorporated by reference herein.

### GOVERNMENT INTERESTS

This invention was made with Government support under Contract No. N68335-15-G-0031. The Government has certain rights in this invention.

### BACKGROUND

Plain spherical bearings are used in a wide variety of mechanical applications. When used in applications with complex loading (i.e. simultaneous directional and rotational loading), wear can be accelerated. When operating in environments rich with particulate, bearings often become contaminated and experience further accelerated wear. Both conditions lead to increased maintenance costs as the bearings are replaced more frequently than in less demanding environments, and replacement can be a labor intensive and costly process. The more that a bearing wears, the more susceptible to contamination it becomes, leading to exponential wear. There is a need for more and better bearing designs to address these and other issues.

### SUMMARY OF THE INVENTION

Some embodiments disclose a bearing assembly comprising two mating interfaces that can move independently about which adjacent component parts may move independently.

Some embodiments further comprise a first component part defining a first mating surface, a second component part defining a first mating surface adjacent the first mating surface of the first component, and a second mating surface, a third component part defining a first mating surface adjacent the second mating surface of the second component; wherein each component may move independently of each other component at an interface of two mating surfaces.

In some embodiments, the first component part is an outer race, and the first mating surface thereof is an inner surface; the second component part is a spherical ball defining an axial bore therethrough, wherein the first mating surface thereof is an outer surface and the bore defines the second mating surface of the second component; the third component is a sleeve contained within the bore and defining an outer surface that is the first mating surface of the third component.

In some embodiments, the sleeve is selected from a tube, a shaft, or an attachment component.

In some embodiments, the sleeve is a tube. In some such embodiments, a shaft is disposed within the tube, and optionally defines another mating interface therewith.

In some embodiments, the sleeve is an attachment component.

Some embodiments further comprise one or more additional component parts, each having at least one additional mating surface for mating to another component part for movement with respect thereto at a mating interface therebetween.

Some embodiments provide a bearing assembly comprising an outer race, a spherical monoball bearing sized and configured for rotation within the outer race, the spherical monoball bearing further comprising a spherical portion, defining an axial bore, an inner sleeve sized and configured for placement and rotation within the axial bore of the spherical portion, and an inner wear liner between the inner sleeve and the spherical portion, the inner sleeve and the spherical portion define a serpentine gap therebetween optionally containing a seal to limit the influx of contaminants; and an outer wear liner between the outer race and the spherical monoball bearing.

In some embodiments, the inner sleeve and the spherical portion lock together and act in unison when friction in the inner wear liner greatly increases due to severe wear or contamination.

In some embodiments, the sleeve further comprises one or more flange engaging the spherical portion.

In some embodiments, the inner sleeve comprises two top hat bushings.

In some embodiments, the inner sleeve comprises a tube-only construction.

Some embodiments, further comprise one or more seals between outer surfaces of the inner sleeve and the spherical portion.

In some embodiments, the inner sleeve and the spherical portion do not contain a serpentine gap.

In some embodiments, the bearing assembly further comprises a compliant layer disposed between the inner wear liner and the inner wear surface of the outer race.

In some embodiments, the liner comprises a low friction or self-lubricating material.

In some embodiments, there is no liner and user-added lubricant.

In some embodiments, compliant layer comprises thermoplastic or elastomeric polymers, composite materials, metals, woven and non-woven materials, fabrics, plastic wool, steel wools, steel spring, and the like, fiber reinforced materials, carbon fiber reinforced polymers or metal composites, and combinations thereof.

In some embodiments a rolling element bearing contains the outer race.

In some embodiments the inner sleeve is a rolling element bearing.

In some embodiments the inner wear liner rotates against the attachment component.

In some embodiments the inner wear liner is part of the attachment component.

### DESCRIPTION OF DRAWINGS

For a better understanding of the disclosure and to show how the same may be carried into effect, reference will now be made to the accompanying drawings. It is stressed that the particulars shown are by way of example only and for purposes of illustrative discussion of the preferred embodiments of the present disclosure only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a drawing illustrating an example of a double bearing assembly according to some embodiments.

FIG. 1a is an enlarged view of the double bearing assembly of FIG. 1.

FIG. 2a is a drawing illustrating the bearing motion before sleeve to ball lockup, illustrating monoball movement within the race.

FIG. 2b is a drawing illustrating the bearing motion after sleeve to ball lockup, illustrating monoball movement within the race.

FIG. 3a is a drawing illustrating the bearing motion before sleeve to ball lockup, highlighting the separate motion of the sleeve within the monoball.

FIG. 3b is a drawing illustrating the bearing motion after sleeve to ball lockup, highlighting the motion of the sleeve and the monoball as a unit.

FIGS. 4a-4d are drawings illustrating various embodiments of the sleeve portion of the bearing.

FIG. 5 is a perspective view of an embodiment disclosed herein having a hexagonal shaft.

FIG. 6 is a cross-sectional view of an embodiment of FIG. 5.

FIG. 7 is a cross-sectional view of an embodiment employing an attachment component as a bearing element.

FIG. 8 is a cross-sectional view of an embodiment in accordance herewith, having a frusto-conical component.

FIG. 9 is a cross-sectional view of an embodiment employing roller bearings.

FIG. 10 is another cross-sectional view of an embodiment employing roller bearings.

FIG. 11 is a illustration depicting several cross-sectional views to illustrate a mating interface of some embodiments.

FIG. 12 is a cross-sectional view illustrating a serpentine gaps employed in some embodiments.

FIG. 13 is a cross-sectional view illustrating a straight gap employed in some embodiments.

FIG. 14 is a cross-sectional view illustrating various components of an exemplary embodiment.

FIG. 15 is an illustration depicting several views of an alternative embodiment.

### DETAILED DESCRIPTION

Disclosed herein is a bearing that utilizes two mating surfaces that can move independently and in different directions and or types of movement (e.g. rotational, lateral, translational, etc.) with respect to each other. Many embodiments of the bearing assemblies described herein are designed to have multiple degrees of freedom. A standard, stacked bearing has one degree of freedom (e.g. rotation). The multiple degrees of freedom result from the two surfaces moving in different axis/directions.

In some embodiments, two or more components engage each other at two or more mating surfaces. At such mating surfaces, each element may move independently of the other in one or more directions including rotationally, linearly, translationally, or other direction. The discussion herein is focused on a double bearing design but need not be limited to a double bearing or to the specific design described.

In some embodiments various components can move in unison by locking together either by user choice, or due to wear or contamination. In some embodiments, this locking is due to wear or corrosion is expected and built into the bearing to extend usable life.

The design can support rotational motion in multiple directions, linear motion, or some combination of both.

The design can provide more than two mating surfaces. In some instances, there may be 3, 4, 5, 6 or more mating surfaces.

The various component parts may be of different sizes depending on desired use and/or relative to each other.

Any dimension, including gaps between parts can be selected according to the application or the particular gap. There can be different sized gaps between mating parts.

The bearing design disclosed herein addresses complex loading and contamination issues simultaneously. By splitting loads and motions into two separate axes, whereas a standard spherical monoball carries all loads and motions, this new design essentially doubles the wear area of the bearing and consequentially, at a minimum, doubles the life of the bearing. This new design also prevents the ingress of harmful contaminants effectively extending bearing life in contaminant rich environments.

This new design represents a drop-in replacement for existing bearings, which is capable of operating at high oscillatory speeds and full range of motion. Existing solutions involve either wrapping the bearing in an elastomer boot or cup, or using a squeegee type seal affixed to the rim of the bearing. Existing bearing end user assemblies may not have space for an add-on type of piece, requiring redesign of an entire assembly to accommodate the integration of a new component. The added component also reduces the full range of motion for the bearing. Additionally, they impede inspection of the part, making it more difficult for maintenance personnel to identify when bearings need to be changed. The boot and cup type have been observed to trap contamination once it penetrates the shield. The squeegee style lip seals tend to be limited to low speed applications. The seal material usually has a higher coefficient of friction than the liner material, resulting in the seal overheating and essentially burning up at higher speeds. By using the existing liner as the sealing surface, the design presented here will not have this problem.

Before the present apparatus and methods are described, it is to be understood that they are not limited to the particular components, compositions, methodologies or protocols described, as these may vary. It is also to be understood that the terminology used in the description is for the purpose of describing the particular versions or embodiments only, and is not intended to limit their scope which will be limited only by the appended claims.

It must also be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

The double bearing design disclosed herein consists of a spherical monoball bearing with an inner sleeve that rotates freely within the sphere. This scheme splits loads and motions into two separate axes, whereas a standard spherical monoball carries all loads and motions. Sacrificial, low friction wear liners occupy the space between the ball and outer race and the ball and sleeve. These liners slowly wear over time due to loads, motions, and contamination, causing increased play between elements. The disclosed design provides two discrete wear surfaces instead of one. This serves to more than double the wear life of a standard monoball bearing. In some embodiments, the sleeve is flanged to provide a labyrinth-like seal to reduce contamination ingress. This double bearing design fits within the same physical envelope as a spherical monoball bearing and provides identical mounting interfaces.

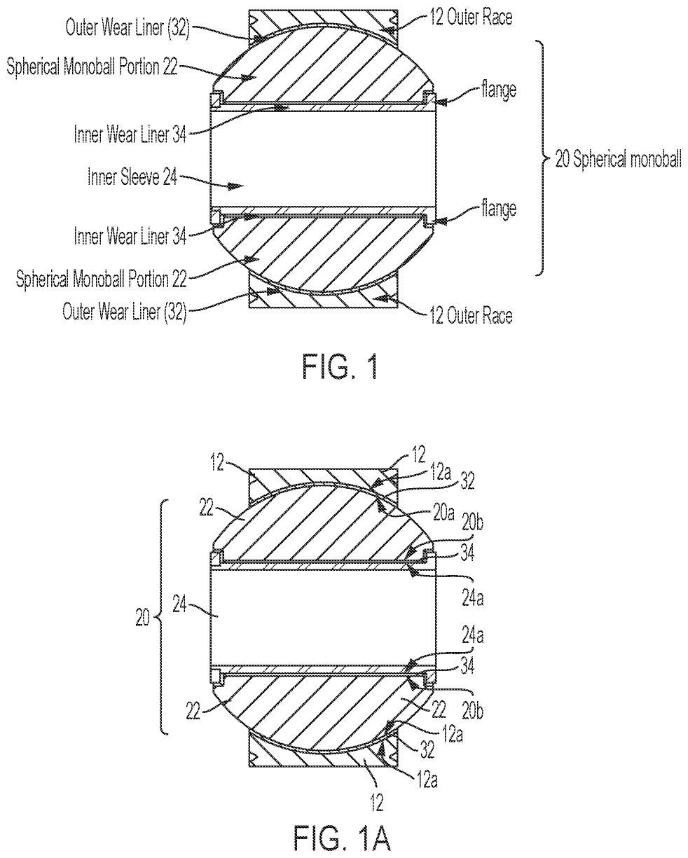

FIG. 1 depicts an exemplary double bearing in accordance with this disclosure. The bearing 10 includes an outer race 12, a spherical monoball bearing 20, having an outer spherical portion 22 defining an axial bore and an inner sleeve 24 located within the axial bore and capable of rotating about the bore's axis. An outer wear liner 32 is provided between an inner wear surface 12a of the outer race 12 and an outer wear surface 20a of the spherical monoball bearing 20. Similarly, an inner wear liner 34 is provided between an inner wear surface 20b of the outer spherical portion 22 and an outer wear surface 24a of the inner sleeve 24.

The sleeve can have flanges at either end that engage the spherical ball to limit its movement. The flanges can be of different sizes and shapes. The sleeve can be two top hat bushings. The sleeve can be a tube only. In tube embodiments, the inner bore maybe have any cross-sectional shape dependent upon the application and the shape of any component passing therethrough, for example the bore may be circular, hexagonal, square, triangular, star or other shape. In some embodiments, the sleeve can be a solid rod. Similarly, when taking a solid form, the solid rod may take any shape, including but not limited to circular, hexagonal, square, triangular, star or other shape. Cylindrical sleeve can be inside or outside of the spherical bearing.

The outer race 12 is, relatively speaking, a stationary object within which the spherical monoball bearing 20 moves. The outer race can be of any suitable material for a particular application. The outer race 12 may be metal, such a steel, stainless steel, aluminum, brass, etc. It may be plastic, or even wood, any suitable rigid material may be used, depending on the application. The spherical monoball bearing and its parts may be of similar or dissimilar materials, again, depending on the application.

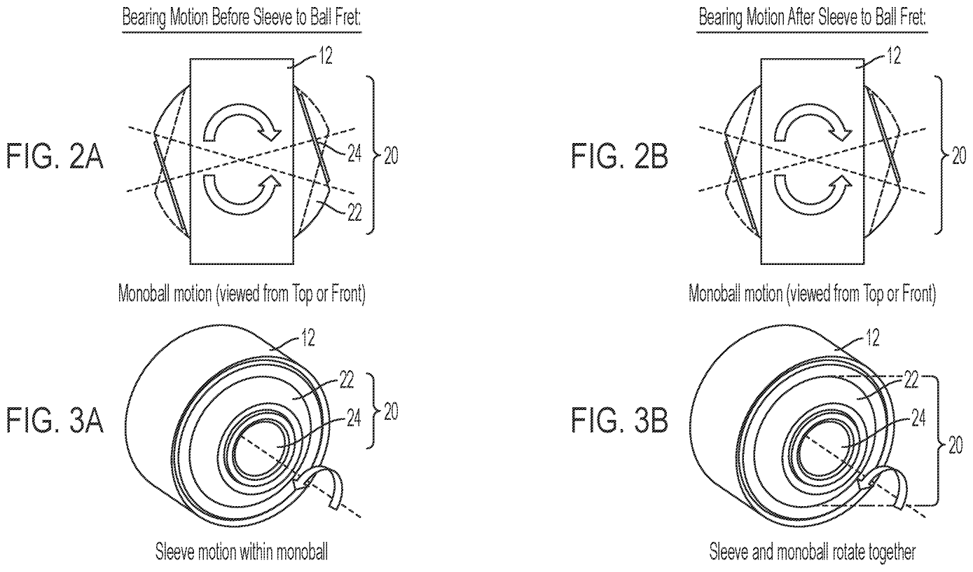

This design recognizes and accounts for the wear on the liners and minimizes wear to extend part life. Particularly, as shown in FIGS. 2a and 2b the spherical monoball bearing 20, is capable of freely rotating within the outer race 12. As with such spherical ball bearings, this rotation can occur about any axis passing through the center of the spherical monoball bearing. The outer wear liner 32 reduces friction during this movement. In typical spherical monoball bearing arrangements, a liner at this position would also take the wear from rotational movement about the access through the center of the race (i.e. passing through the axial bore of the present design). In the bearing disclosed herein, the inner sleeve 24 rotates within the axial bore formed by the spherical monoball bearing portion 22, as shown in FIG. 3a. With this movement, the inner wear liner 34 shares the wear with outer wear liner 32. Eventually, the inner wear liner 34 may wear away at a faster rate than the outer wear liner. In this case, the sleeve material could fret onto the ball bore or allow substantial contamination to enter and essentially connect the inner sleeve 24 to the inner wear surface 22a of the spherical portion 22 of the spherical monoball bearing 20. When this occurs, the sleeve 24 and the spherical portion 22 are fused together and act in harmony as shown in FIG. 3b. The wear time associated with the shared liners effectively extends the useful life of the bearing, since that wear and tear in other designs would have been borne exclusively by the outer wear liner. In some instances it can double or more than double the useful life of the bearing.

Each of the inner and outer wear liners can be of any suitable sacrificial low-friction material. The material used for inner and outer wear liners may be the same or different. The liners of various embodiments may be composed of any material known in the art and useful for making bearing liners. Such materials include, but are not limited to, fabric liners that can be woven, braided, or knitted, tetrafluoroethylene (TFE) materials, polytetrafluoroethylene (PTFE, e.g., Teflon), polyethereketone (PEEK), and the like and combinations thereof.

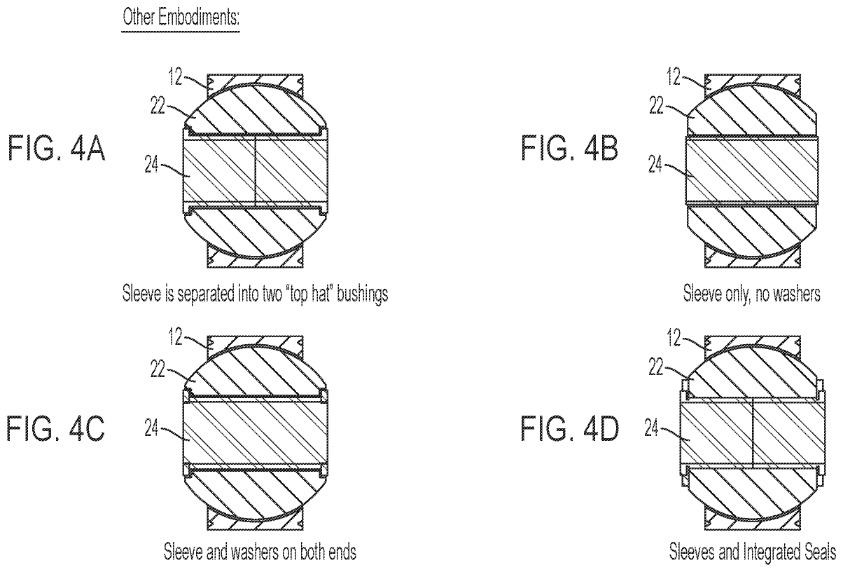

The sleeve portion can be formed by any appropriate means. FIG. 4a depicts a sleeve comprising two top hat bushings, where flange ends engage outer faces of the spherical monoball portion. FIG. 4b depicts a simple sleeve arrangement, essentially a hollow cylinder passing from one side of the spherical monoball portion to the other. FIG. 4c discloses a sleeve arrangement with washers or flanges at the outer ends. FIG. 4d shows the top hat construction of FIG. 4a with additional integrated seals. Additional seals may be incorporated into any design. Designs which include flanges or washers present an additional serpentine structure which makes it more difficult for contaminants to disrupt the bearing's normal operation.

As contemplated herein, the bearing can have one or more seals between outer surfaces of moving components, that is at or between mating surfaces. To minimize contamination, one or more gaps between component parts may be comprised of a serpentine gap. A serpentine gap has one or more bends or undulations making it more difficult for contamination to reach a mating surface. In some embodiments, the component parts maybe readily disassembled from one another, while in other embodiments, the component parts may be assembled in a permanent system not suitable for disassembly. Such “permanent” embodiments which are not meant to be disassembled allow for stricter tolerances, which may be important for certain applications.

One or more mating surfaces can be elastomeric. One or more mating surface can comprise a liner which is a low friction or self-lubricating material. Some embodiments may be liner free, some may use lubricants. Lubricant could be oil, grease, graphite, air, etc. An air bearing or maglev could also be used.

Some embodiments may further include a compliant material between the liner and a contacting surface to maintain contact between the liner and the ball or shaft surface. In use, the compliant layer is compressed when the bearing contacts the liner. The compliant layer may maintain low resistance throughout the compression range allowing the compliant layer to force the liner to maintain contact with the bearing surface as the liner wears, extending the life of the bearing. The compliant layer and the low friction liner may also be combined to provide a single low friction compliant material that both maintains contact with the mating surface and serves to maintain low friction. Bearings including such compliant materials are disclosed in US Pre-Grant Publication no. US 2015-0211579 filed Jan. 28, 2015 entitled LINER-AS-SEAL BEARINGS, which is hereby incorporated by reference in its entirety for any purpose.

The compliant layer may be any material known in the art including, for example, thermoplastic or elastomeric polymers, steel springs, composite materials, metals, woven and non-woven materials such as fabrics, plastic wool, steel wools, and the like, fiber reinforced materials such as carbon fiber reinforced polymers or metal composites, and the like and combinations thereof. In various embodiments, the compliant layer may be composed of a material having, for example, high shear strength, low resistance to compression, high compressive strength, resistance to heat and/or cold, chemical resistance, and the like and combinations thereof.

High shear strength defines the maximum force that tends to produce material failure along a plane that is parallel in direction to the direction of the force. In some embodiments, the compliant layer may be composed of a material having a shear strength of greater than about 1000 pound force per square inch (psi), for example, about 1000 psi to about 70,000 psi, about 1200 psi to about 60,000, about 1500 psi to about 50,000 psi, about 2000 psi to about 40,000 psi, or any range or individual value encompassed by these example ranges.

Resistance to compression is generally a measure to how resistant a compound or composition is to deformation when force is applied. The compliant layer may generally exhibit low resistance to compression, for example, less than about 20 psi/0.001 inches (in) or less than about 20,000 psi/in. In some embodiments, the compliant layer may exhibit a resistance to compression of about 100 psi/in to about 20,000 psi/in, about 150 psi/in to about 15,000 psi/in, about 200 psi/in to about 10,000 psi/in, or any range or individual value encompassed by these example ranges.

In certain embodiments, such materials may have a compression set of greater than 5%, about 5% to about 50%, about 8% to about 40%, about 10% to about 30%, or any range or individual value encompassed by these example ranges. Compression set is a measure of permanent deformation that occurs when a force is applied to a material and then removed and refers to the percentage of original specimen thickness after the specimen has been left in normal conditions for a period of time, typically 30 minutes. The response time of the materials used in the compliant layer, i.e., the time necessary for the compressed specimen to fully deform may be less than 0.1 seconds, for example, about 0.001 seconds to 0.1 seconds, about 0.005 to about 0.05, or any range or individual value encompassed by these example ranges.

Compressive strength is a measure of the maximum uniaxial compressive force that can be applied to a material before the material fails. The compliant layer may generally exhibit high compressive strength of, for example, greater than 500 psi, and in various embodiments, the compressive strength exhibited by the compliant layer may be about 500 psi to about 35,000 psi, about 1000 psi to about 20,000 psi, about 1500 psi to about 10,000 psi, about 1500 psi to about 5000 psi, or any range or individual value encompassed by these example ranges.

Resistance to heat and cold refers to the ability of a material to maintain its structural integrity and physical properties such as shear strength, resistance to compression, and compressive strength when exposed to high or low temperatures. The compliant layer of various embodiments may exhibit resistance to heat, cold, or both heat and cold. For example, the compliant layer may be composed of a material resistant to heat and cold at temperatures of about −60° C. to about 400° C., about −40° C. to about 350° C., about −30° C. to about 300° C., about −20° C. to about 250° C., or any range or individual value encompassed by these example ranges.

Chemical resistance means that the material used in the compliant layer is inert or substantially inert to chemicals that it may contact. The compliant layer may be chemically resistant to a wide range of chemicals including, for example, water, various solvents such as alcohols and fluorinated and chlorinated hydrocarbons, and oils, grease, and other hydrophobic chemicals. In some embodiments, the compliant material may be non-porous.

Examples of materials that exhibit some combination of these physical properties include, but are not limited to, polyisoprene, cis-1,4-polyisoprene natural rubber (NR), trans-1,4-polyisoprene gutta-percha, synthetic polyisoprene (IR), polybutadiene (BR), chloroprene rubber (CR), polychloroprene, Neoprene, Baypren, butyl rubber, copolymers of isobutylene and isoprene (IIR), halogenated butyl rubbers, chloro butyl rubber (CIIR), bromo butyl rubber (BIIR), styrene-butadiene rubber (SBR), nitrile rubber, copolymer of butadiene and acrylonitrile (NBR), hydrogenated nitrile rubbers (HNBR), saturated rubbers, ethylene propylene rubber (EPM), ethylene propylene diene rubber (EPDM), epichlorohydrin rubber (ECO), polyacrylic rubber (ACM, ABR), silicone rubber (SI, Q, VMQ), fluorosilicone rubber (FVMQ), fluoroelastomers (FKM, and FEPM), perfluoroelastomers (FFKM), polyether block amides (PEBA), chlorosulfonated polyethylene (CSM), ethylene-vinyl acetate (EVA), and various co-polymers and combinations thereof.

In some embodiments, the compliant layer may include one or more physical features that allow the material of the compliant layer to exhibit particular properties. For example, in some embodiments, two or more different materials may be bonded to one another to produce a compliant layer having a suitable combination of shear strength, resistance to compression, and compressive strength. In other embodiments, the compliant layer may include cavities which constrain the material so that further compression is restricted by the bulk modulus rather than the elasticity thereby increasing force that can be supported by the structure. In still other embodiments, the socket, ball, or shaft may include cavities positioned to allow the compliant material to change shape. For example, the socket 14 may include grooves or indentations that allow the compliant layer to compress more easily reducing the force needed for sufficient expansion as the bearing wears.

In particular embodiments, the compliant layer may consist of o-rings of compliant material that are fit into o-ring grooves cut into the appropriate surfaces.

The compliant layer may have various configurations. For example, in some embodiments, the compliant layer may be a continuous layer of material that is bonded to race of the housing, ball, or shaft. In other embodiments, one or more portions of the race of the housing, ball, or shaft may be coated in the compliant material. For example, the compliant layer may be composed of one or more pads attached to the race, ball, or shaft, and in some embodiments, a grid of such pads may be attached to the race, ball, or shaft. In certain embodiments, the pads may be laid out along the circumference of the race, ball, or shaft. In some embodiments, the compliant material may be composed of rings or bands of the compliant material attached to the race, ball, or shaft that substantially or fully cover the circumference of the race, ball, or shaft.

In each of the embodiments described above, the compliant layer may be attached to the race, ball, or shaft by being physically bonded to the bearing using, for example, a bonding agent or adhesive. In other embodiments, the compliant layer may be attached to the race, ball, or shaft by the force of the ball or shaft against the race. Such embodiments, therefore, do not require the use of a bonding agent or adhesive. In other embodiments, the liner may facilitate attachment of the compliant layer to the race, ball, or shaft. For example, the liner may be bonded to the outer race around the compliant layer to hold the compliant layer in place, or the liner may fully encapsulate the compliant layer such that the liner is bonded to the race, ball, or shaft and not the compliant layer. In certain embodiment, the liner may hold the compliant layer in place. For example, the compliant layer may not be physically attached the mounting surface, and may be held in place by the liner, which overlies the compliant layer and is physically attached to the mounting surface at the outer edge of the compliant layer or at holes in the compliant layer. In particular embodiments, the compliant layer may be o-rings and the liner may hold the o-rings in place by attaching to the mounting surface one either side of the o-rings. Such embodiments can be incorporated into bearings having grooves for retaining the o-rings or embodiments in which the o-rings are not retained in grooves.

The thickness of the compliant layer may vary among embodiments. In particular embodiments, the thickness of the compliant layer may be substantially the same along every concave surface of the mounting surface. In other embodiments, the thickness of the compliant layer may vary. In still other embodiments, the density of the compliant layer may vary axially over the surface of the mounting surface.

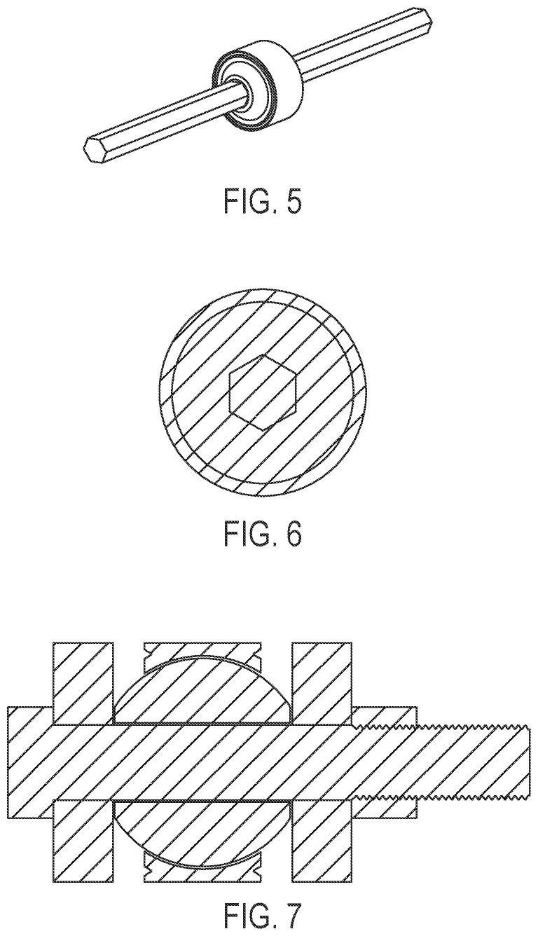

It should be appreciated that many design choices are available without deviating from the scope and spirit of this disclosure. For example, the inner sleeve could be a rolling element bearing, could rotate against an attachment component. The inner wear liner could be part of an attachment component. One or more bearing surfaces could be spherical, cylindrical, tapered, or other shapes. Mating surfaces can be designed to achieve preferential motion for one surface or another—i.e. the bearing can be designed such that one surfaces moves preferentially (before/rather than) the others. Stop gauges or other features may be employed to limit movement. FIGS. 5-13 show some of these design features and choices.

FIG. 5 depicts a bearing as described above, where a hexagonal shaft goes through the sleeve. The sleeve and bearing are free to move longitudinally along the shaft, but the shaft and sleeve rotate together, due to the hexagonal nature of the shaft. The sleeve may be adapted to rotate within the ball or along with it as described above. FIG. 6 shows a cross-section.

FIG. 7 shows the case where the sleeve is actually an attachment member used to affix the bearing to a larger structure. Here we see the ball may rotate about the sleeve (e.g. bolt), and may tilt with respect to the outer race. The position of the ball on the sleeve (e.g. bolt) is fixed.

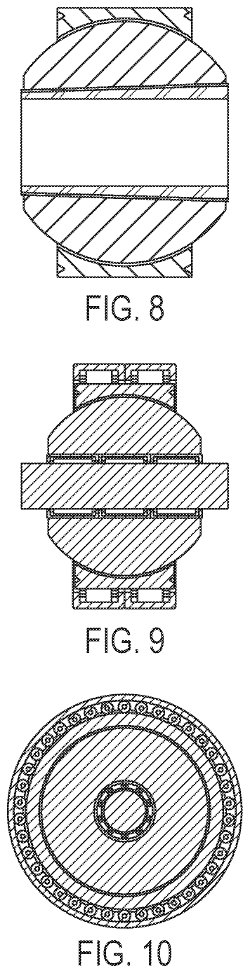

FIG. 8 illustrates the concept that various shapes can be used. Here, the sleeve is a frusto-conical shape which has complimentary surface on the inside of the ball.

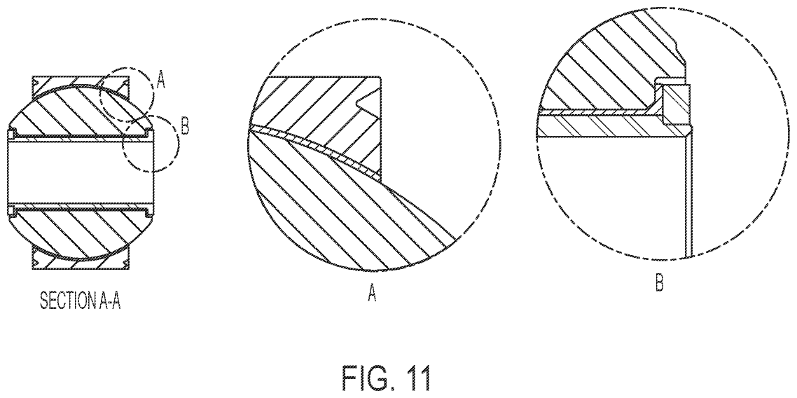

FIGS. 9 and 10 illustrate an embodiment where mating surfaces engage a series of rollers which reduce friction during movement. These rollers may be ball roller or cylindrical rollers.

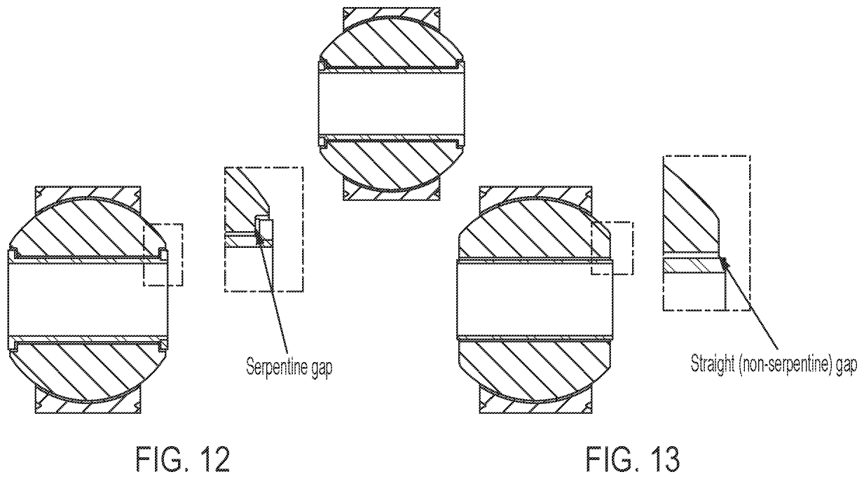

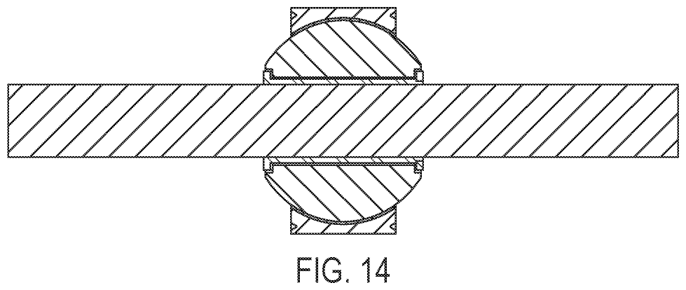

FIG. 11 shows cross-sectional views highlighting the gaps between various component parts with arrows. As noted above, the gaps may vary in size from gap to gap or even within a gap. The gap may be filled with lubricant, a seal, a liner, an elastic bearing, or other material. FIGS. 12 and 13 show various forms of the gap, including a serpentine gap or no serpentine gap.

In some embodiments, the sleeve may accept a rod or shaft, which maybe round, square, hexagonal, or other cross-sectional shape. In such instances, the shaft maybe be adapted for movement within the sleeve or not. For example, the shaft could move longitudinally within the sleeve (or sleeve longitudinally along the shaft), or it could be fixed against longitudinal movement. The shaft could rotate within the sleeve or rotate with the sleeve. Combinations of these are also possible.

FIG. 14 shows an exemplary bearing in accordance with some embodiments. Each differently hatched component part can move independently of the adjacent part (or if desired could be designed to move together). The ball can tilt clockwise or counterclockwise, or into or out of the page (direction based on the view shown) or can rotate within the outer race. The inner sleeve can rotate within the ball, and because as shown there are flanges, cannot move laterally. As will all components, the sleeve could rotate within the ball, or the ball about the sleeve if it were otherwise fixed. The two components may also be designed to move with each other, or preferentially one over the other, or together only upon sufficient wear or contamination. Finally, the shaft may rotate independently within the sleeve or as above, with the sleeve. The shaft could move longitudinally within the sleeve, or the sleeve could slide longitudinally along the shaft. As described above, the shaft could be locked in place rotationally, most efficiently with a non-round cross-section, but other means may be used. The sleeve could also be locked in place along the length of the shaft. Between each component is a gap, which may be empty, filled with lubricant, a seal, a liner, a compliant layer, an elastic bearing, or other. With this figure many different possibilities can be seen.

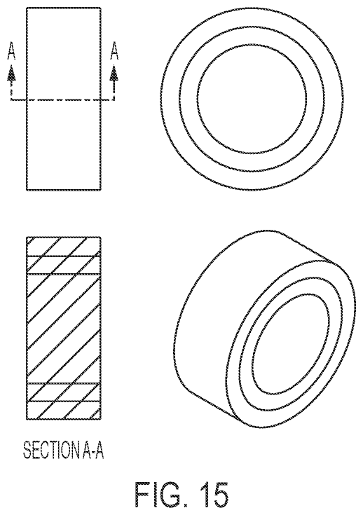

FIG. 15 shows the bearing described herein could use any shape or bearing; here, a cylinder within a cylinder is shown. The outer cylinder and the inner cylinder can rotate freely with respect to each other as can a shaft (not shown) within the inner cylinder. The shaft could also move longitudinally through the inner shaft. Applicants are not limited to the specific designs shown and described herein.

What is claimed is:

1. A bearing assembly comprising the following components:
an outer race
a spherical monoball bearing sized and configured for rotation within the outer race, the spherical monoball bearing further comprising:
a spherical portion, defining an axial bore,
an inner sleeve sized and configured for placement and rotation within the axial bore of the spherical portion, and
an inner wear liner between the inner sleeve and the spherical portion; and
an outer wear liner between the outer race and the spherical monoball bearing.

2. The bearing assembly of claim 1, wherein the inner sleeve and the spherical portion lockup and act in unison when friction in the inner wear liner greatly increases due to excessive wear or contamination.

3. The bearing assembly of claim 1, wherein the sleeve further comprises one or more flanges engaging the spherical portion.

4. The bearing assembly of claim 1, wherein the inner sleeve comprises two top hat bushings.

5. The bearing assembly of claim 1, wherein the inner sleeve comprises a tube-only construction.

6. The bearing assembly of claim 1, further comprising one or more seals between outer surfaces of the inner sleeve and the spherical portion.

7. The bearing assembly of claim 1, wherein the inner sleeve and the spherical portion define a serpentine gap therebetween optionally containing a seal to limit the influx of contaminants.

8. The bearing assembly further comprising a compliant layer disposed between the inner wear liner and the inner wear surface of the outer race.

9. The bearing assembly of claim 7, the liner comprises a low friction or self-lubricating material.

10. The bearing assembly of claim 7, wherein compliant layer comprises thermoplastic or elastomeric polymers, composite materials, metals, woven and non-woven materials, fabrics, plastic wool, steel wools, steel spring, and the like, fiber reinforced materials, carbon fiber reinforced polymers or metal composites, and combinations thereof.

11. A bearing assembly comprising two mating interfaces that can move independently about which adjacent component parts may move independently.

12. The bearing assembly of claim 11, further comprising:
a first component part defining a first mating surface,
a second component part defining a first mating surface adjacent the first mating surface of the first component, and a second mating surface,
a third component part defining a first mating surface adjacent the second mating surface of the second component;
wherein each component may move independently of each other component at an interface of two mating surfaces.

13. The bearing assembly of claim 11, wherein each of the first, second, or third component is independently selected from a spherical ball bearing, a race, and a sleeve.

14. The bearing assembly of claim 12, wherein
the first component part is an outer race, and the first mating surface thereof is an inner surface;
the second component part is a spherical ball defining an axial bore therethrough, wherein the first mating surface thereof is an outer surface and the bore defines the second mating surface of the second component;
the third component is a sleeve contained within the bore and defining an outer surface that is the first mating surface of the third component.

15. The bearing assembly of claim 14, wherein the sleeve is selected from a tube, a shaft, or an attachment component.

16. The bearing assembly of claim 13, wherein the sleeve is a tube.

17. The bearing assembly of claim 14, wherein a shaft is disposed within the tube, and optionally defines another mating interface therewith.

18. The bearing assembly of claim 15, wherein the sleeve is an attachment component.

19. The bearing assembly of claim 15, wherein the sleeve is a shaft.

20. The bearing assembly of claim 12, further comprising one or more additional component parts, each having at least on additional mating surface for mating to another component part for movement with respect thereto at a mating interface.
